(19) United States
(12) Patent Application Publication
(10) Pub. No.: US 2002/0125346 A1
(43) Pub. Date: Sep. 12, 2002

(54) Fuel Injector

(76) Inventor: Uwe LIskow, Pleidelsheim (DE)

Correspondence Address: KENYON & KENYON, ONE BROADWAY, NEW YORK, NY, 10004, US

(21) Appl. No.: 09/913,479

(22) PCT Filed: Dec. 14, 2000
(86) PCT No.: PCT/DE00/04453

(30) Foreign Application Priority Data
Dec. 15, 1999 (DE) 199 60 33911

(51) Int. Cl. F02M 51/00

(52) U.S. Cl. 239/585.1

(57) ABSTRACT

A fuel injector (16) for fuel injecting systems of internal combustion engines having a valve needle (3) has a valve seat surface (1) at a valve seat element (2). The valve seat surface (1) acts together with a valve closing element (5) to form a sealing seat (4). The fuel injector (16) further has a magnetic coil (6), an armature (8) engaging the valve needle (3), and at least one fuel channel (9) on armature (8) and/or valve needle (3) for supplying fuel to sealing seat (4). Fuel channel (9) has a flow valve (10) which throttles the fuel flow through fuel channel (9) more strongly during a closing movement of the armature (8) than during an opening movement of armature (8). In one specific embodiment, flow valve (10) is activated by a magnetic field (11) generated by magnetic coil (6) and an operating element (14) made of ferromagnetic material.

### BACKGROUND INFORMATION

The present invention is based on a fuel injector of the type set forth in the main claim. From DE 196 26 576 A1 a fuel injector is known in which fuel is routed through borings in the armature. In that known specific embodiment, these borings are used, in addition to supplying fuel, for the compensation of an undesired component of force in a direction towards the valve seat surface, since the flow-through direction of the fuel at that place runs counter to this direction. The known embodiment has the disadvantage that, even though it makes possible a more rapid opening movement of the fuel injector, on an overall basis it requires greater force for this. The faster the opening movement is made possible, the less fast can the closing movement be carried out. Also in DE 196 26 576 A1, an embodiment is described in which grooves are used instead of borings. This embodiment too has the same disadvantages. It does not make possible a distinction between opening and closing movement. However, especially in the case of high pressure injection valves (HDEV), not only rapid opening but also rapid closing is required.

### SUMMARY OF THE INVENTION

The fuel injector according to the present invention having the characterizing features of the main claim has the advantage, compared to this, that by throttling of the flow-through in the at least one fuel channel during the closing movement of the armature, its closing movement is accelerated in that the inert mass of the streaming fuel additionally accelerates the armature and the valve needle. This is achieved in that at least one fuel channel is provided in the armature and/or at the valve needle which has a flow-valve, the use of the flow valve making it possible to additionally throttle the fuel flow through the fuel channel. During the opening of the armature the flow valve is open, and the resistance is low because of the throttling of the passage of the fuel. Above all, the resistance can be held low by large-dimensioned design of the fuel channel. During the closing movement, the flow valve throttles the fuel flow more strongly by closing as far as possible. The entire inert mass of the fuel in motion ahead of the flow valve then exerts an additional force on armature and needle in the direction of the valve seat surface. By appropriate design one can thus achieve a very short closing time, without substantially lengthening the opening time of the fuel injector.

The measures specified in the subclaims permit advantageous further developments and improvements of the compensating element indicated in the main claim.

The fuel injector according to the present invention, according to the subclaims, has the further advantage thatthe flow valve, which is located at the moved parts armature and/or valve needle, can be simply activated in that the magnetic field induced by the magnetic coil of a fuel injector also activates the flow valve. This is possible since the magnetic field is induced during the opening movement, but not during the closing movement. Advantageously, no additional electrical or hydraulic activation is required. The switching times of the flow valve have just the time delay necessary for the decay of the field strength of the magnetic field.

As an advantageous further refinement, it is possible to prestress the flow valve by using a spring, and setting thereby the opening and closing behavior of the flow valve. By using a permanent magnet for the activating element a greater opening force and thus a more favorable flow-through resistance of the flow valve can be made possible.

### BRIEF DESCRIPTION OF THE DRAWINGS

Exemplary embodiments of the invention are explained in greater detail in the following description and are shown simplified in the drawing. The figures show:

FIG. 1 an axial section through a fuel injector of the species,

FIG. 2A an axial detailed section through a first exemplary embodiment of the fuel injector according to the present invention during a weak magnetic field,

FIG. 2B a partial section through the armature in FIG. 2A during a strong magnetic field,

FIG. 3A a partial section through an armature corresponding to a second exemplary embodiment during a weak magnetic field, and

FIG. 3B a partial section through the armature of the embodiment according to FIG. 3A during a strong magnetic field.

### DESCRIPTION OF THE EXEMPLARY EMBODIMENTS

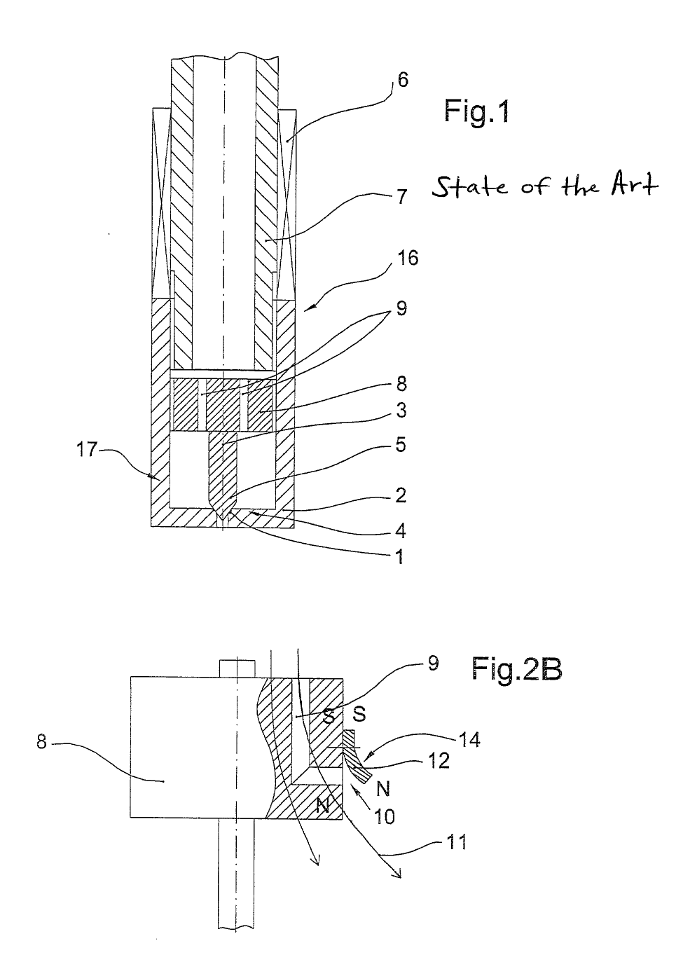

For clarification, FIG. 1 shows a fuel injector 16 of the species in a known embodiment having electromagnetic activation. Fuel injector 16 has a valve seat surface 1 which is situated at a valve seat body 2 which forms the downstream part of valve housing 17 of fuel injector 16, which is here only represented schematically. A valve needle 3, developed at its lower part as a valve-closure member 5, acts together with valve seat surface 1 to form a sealing seat 4. A magnetic coil 6, in whose inside a core 7 is positioned, induces a magnetic field during the opening of fuel injector 1 which attracts armature 8, made of ferromagnetic material, which is connected to the valve needle 3 with an interference fit, and thereby lifts valve-closure member 5 from valve seat surface 1.

Fuel channels 9, borings at this point, are provided in armature 8 for the supply of fuel to sealing seat 4. By the suitable dimensioning of fuel channels 9 it can be achieved that they throttle the passage of fuel only a little when fuel injector 1 is opened. But that causes the closing motion of armature 8 and valve needle 3 not to be supported by the inertia of the flowing fuel or ram pressure, respectively, since, after all, only a low resistance against the passage of fuel is present in the closing direction.

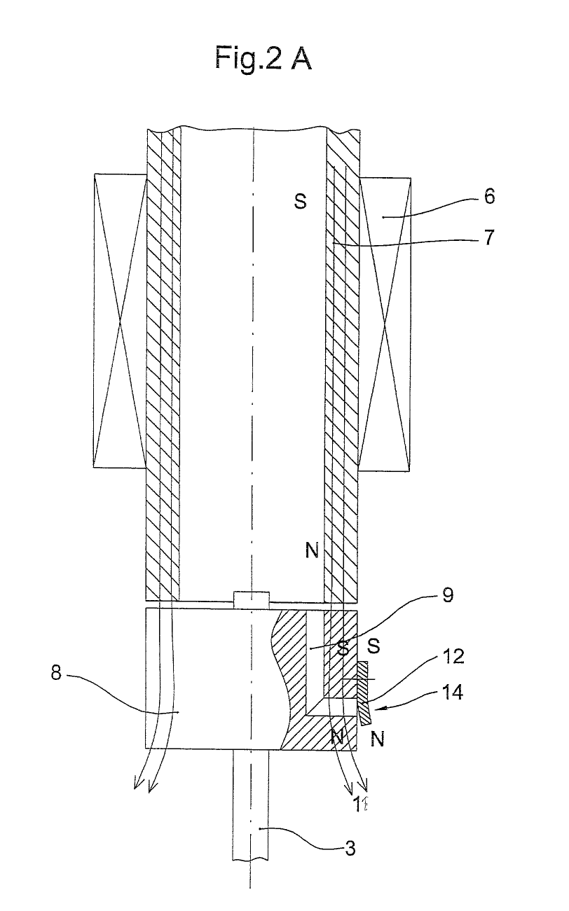

Accordingly, the first exemplary embodiment according to the present invention shown in FIGS. 2A and 2B provides a flow-valve 10 at fuel channel 9 which additionally throttles the flow-through during the closing movement. The embodiment illustrated in FIG. 2A and 2B provides a reed valve for this, activated by a magnetic field. FIG. 2A shows as detail in axial section magnetic coil 6, core 7 and magnetic field 11 represented by flux lines. Furthermore, armature 8, shown as detail section partially axially cut into, is formed with a fuel channel 9 and a flow-valve 10 on the outer circumference of armature 8.flow-valve 10 is a flexible reed 12 which, in this embodiment, forms an operating element 14. Flexible reed 12 can be fastened to armature 8 by clamping, clipping on, welding, riveting, crimping or cementing.

The orientation of flexible reed 12 fastened to armature 8 is essentially parallel to magnetic field 11. The essential thing in this embodiment is the essentially parallel alignment to the approximate course of magnetic field 11, and the position in the magnetic field next to armature 8. Because of the necessity of closing the flux lines, in order to transmit the requisite attractive forces to armature 8, a diversion of the flux lines to valve housing 17 of fuel injector 16 takes place because this enables the flux lines to be closed. Flexible reed 12 of flow valve 10 advantageously opens as soon as there is a magnetic field, by equal magnetic poles being formed at armature 8 and flexible reed 12, and these repel one another. The magnetic poles are indicated by N for north pole and S for south pole.

FIG. 2B shows armature 8 as detail, partially cut into by fuel channel 9 and flow valve 10 having flexible reed 12 during a strong magnetic field 11. Flexible reed 12 is repelled by the equal magnetic poles. The flow-through resistance is then low, and the fuel supply is hardly throttled.

During the closing motion, magnetic field 11 returns in a short time to the lowest field strength, and flexible reed 12 takes up a position as in FIG. 2A. Flow-through is severely throttled, and armature 8 is carried along in the direction of sealing seat 4 by the mass inertia or ram pressure of the moving fuel.

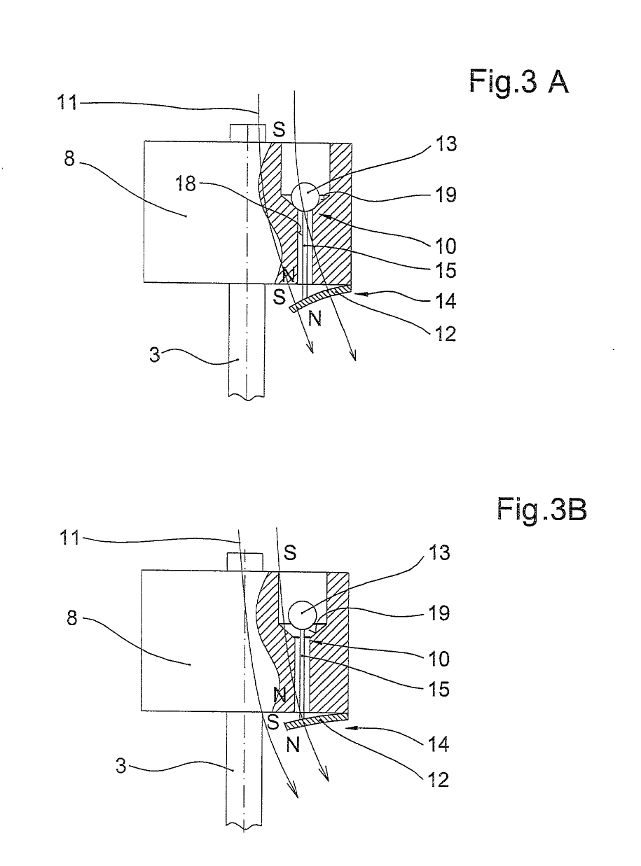

A second specific embodiment of the present invention is shown in detail drawings FIGS. 3A and 3B. FIGS. 3A and 3B each show an axial section of an armature 8. Here flow valve 10 is designed as a seat valve. FIG. 3A shows the closed state of flow valve 10.flow-valve 10 includes an operating element 14, which, in this instance, is again fashioned as a flexible reed 12, whereby a simple and nevertheless flexible attachment to armature 8 is possible. Here, too, attachment to armature 8 can be achieved by clamping, clipping on, welding, riveting, crimping or cementing. Furthermore, a flow valve closing element 13 is provided here in the form of a ball which is connected to operating element 14 via a connecting element 15.

Connecting element 15 passes through a boring 18. When there is no magnetic field 11, or only low field strength, flow-valve closing element 13 is drawn by flexible reed 12 into its seat 19, and during the closing motion of armature 8 it is additionally pressed into its seat 19 by the flowing fuel. That makes achievable a particularly rapid closing of flow valve 10 and a very strong throttling of fuel passage during the closing movement of armature 8.

FIG. 3B shows the armature illustrated in FIG. 3A, including the described elements, while there is a strong magnetic field. In this embodiment, operating element 14 and armature 8 are essentially arranged in series with respect to the magnetic flux lines. Thus are formed mutually attracting magnetic poles, which are shown clearly in FIG. 3B. The magnetic poles attract one another, and operating element 14 presses flow valve closing body 13 out of its seat 19 via connecting element 15, and opens flow valve 10.

The present invention is not limited to the described exemplary embodiments. In particular, operating element 14 or armature 8 can be designed as permanent magnets, whereby the effect according to the present invention can even be strengthened.

What is claimed is:

1. A fuel injector, especially an injector for fuel injection systems in internal combustion engines, having a valve seat element (2) which has a valve seat surface (1); having a valve needle (3) which has a valve closing element (5) acting together with the valve seat surface (1) to form a sealing seat (4); having a magnetic coil (6) and an armature (8) engaging with the valve needle (3), the armature (8) and/or the valve needle (3) having at least one fuel channel (9) for the supply of fuel to the sealing seat (4),
wherein the fuel channel (9) has a flow valve (10) which throttles the fuel flow through the fuel channel (9) more strongly during a closing movement of the armature (8) than during an opening movement of the armature (8).

2. The fuel injector as recited in claim 1,
wherein the flow valve (10) is activated by a magnetic field (11) caused by the magnetic coil (6) and by an operating element (14) made of ferromagnetic material.

3. The fuel injector as recited in claim 2,
wherein the flow valve (10) is flexibly prestressed.

4. The fuel injector as recited in claim 2 or 3,
wherein the operating element (14), the armature (8) or the valve needle (3) is designed as a permanent magnet.

5. The fuel injector as recited in one of claims 2 through 4,
wherein the flow valve (10) is made as a reed valve, a flexible reed (12) acting as operating element (14) being fixed to the armature (8) in a manner that it is oriented essentially in parallel to the magnetic flux lines of the magnetic field (11) generated by the magnetic coil (6);
the flexible reed at least partially overlapping the cross section of the fuel channel (9) and freeing the cross section of fuel channel (9) by the formation of repelling equal magnetic poles during generation of the magnetic field (11) by the magnetic coil (6).

6. The fuel injector as recited in one of claims 2 through 4,
wherein the flow valve (10) is designed as a seat valve, having a flow-valve closing element (13), which is connected to an operating element (14) oriented in the direction of the magnetic flux lines of the magnetic field (11) generated by the magnetic coil (6), the operating element (14) projecting so far from the armature (8) that the flow-valve closing element (13) is displaced by the formation of mutually attracting, different magnetic poles during generation of the magnetic field (11) by the magnetic coil (6).

7. The fuel injector as recited in claim 6,
wherein the flow-valve closing element (13) is connected via a connecting element (15) to the operating element (14) lying outside the armature (8).

8. The fuel injector as recited in claim 7,
wherein the operating element (14) is formed as a flexible reed (12).
